(19) United States
(12) Patent Application Publication
(10) Pub. No.: US 2015/0304751 A1
(43) Pub. Date: Oct. 22, 2015

(54) CHIP-STACKED MICROPHONE

(71) Applicant: MERRY ELECTRONICS (SHENZHEN) CO., LTD., Shenzhen (CN)

(72) Inventors: Jen-Yi CHEN, Taichung City (TW); Chao-Sen CHANG, Taichung City (TW); Chun-Chieh WANG, Taichung City (TW); Yong-Shiang CHANG, Taichung City (TW)

(73) Assignee: MERRY ELECTRONICS (SHENZHEN) CO., LTD., Shenzhen (CN)

(21) Appl. No.: 14/255,420

(22) Filed: Apr. 17, 2014

(51) Int. Cl. H04R 1/04

(52) U.S. Cl. CPC H04R 1/04

(57) ABSTRACT

A chip-stacked microphone includes a cover, an acoustic wave transducer module, an application-specific integrated circuit chip (ASIC) and a substrate arranged in proper order from top to bottom. The cover is connected to the substrate and covered over the acoustic wave transducer module, providing a sound hole. The application-specific integrated circuit chip (ASIC) is electrically connected to the substrate. The acoustic wave transducer module is electrically connected to the application-specific integrated circuit chip (ASIC) using a 3D packaging technology, allowing an acoustic wave to pass therebetween. Thus, the invention greatly reduces the area for footprint and fully utilizes the space between the cover and the two modules for back chamber to maintain the overall performance of the microphone.

### BACKGROUND OF THE INVENTION

1. Field of the Invention

The present invention relates to microphone technology, and more particularly to a chip-stacked microphone that comprises an application-specific integrated circuit chip (ASIC) and an acoustic wave transducer module stacked on the application-specific integrated circuit chip (ASIC), having the characteristics of small size and sufficient back chamber space.

2. Description of the Related Art

A conventional microphone 70, as shown in FIG. 1, generally comprises an acoustic wave transducer module 72 and an application-specific integrated circuit chip (ASIC) 73 both mounted at a substrate 71. The substrate 71 has a sound hole 711 disposed at a bottom side relative to a diaphragm 721 of the acoustic wave transducer module 72. Further, a cover 74 is covered over the acoustic wave transducer module 72 and the application-specific integrated circuit chip (ASIC) 73, thus, the cover 74 defines with the acoustic wave transducer module 72 and the application-specific integrated circuit chip (ASIC) 73 a back chamber 75 that provides the diaphragm 721 of the acoustic wave transducer module 72 with a partial elastic restoring force, thereby adjusting the acoustic impedance of the microphone and its overall frequency response characteristic and imparting a very huge impact on the overall performance. However, because the acoustic wave transducer module 72 and the application-specific integrated circuit chip (ASIC) 73 are disposed adjacent to each other, the substrate 71 must provide sufficient surface area for the footprint of the acoustic wave transducer module 72 and the application-specific integrated circuit chip (ASIC) 73. In consequence, the size of the substrate 71 must be relatively increased.

To solve the aforesaid problem, some commercial microphones have the acoustic wave transducer module be stacked on the application-specific integrated circuit chip (ASIC) and make a through hole at the center of application-specific integrated circuit chip (ASIC) and a sound hole at the substrate in alignment with the through hole for the passing of acoustic waves to the diaphragm. A microphone of this design reduces the area demand for footprint, however, the application-specific integrated circuit chip (ASIC) needs to render a space area for making the through hole. Thus, this design has limited effects on reducing the area of the substrate and the overall dimension of the microphone. Further, sacrificing the internal space of the cover not for back chamber will adversely affect the performance of the microphone.

### SUMMARY OF THE INVENTION

The present invention has been accomplished under the circumstances in view. It is the main object of the present invention to provide a chip-stacked microphone, which effectively reduces the area of the substrate and maintains or increases the internal space of the cover for back chamber, achieving the technical effects of small size and high performance.

To achieve this and other objects of the present invention, the invention provides a chip-stacked microphone comprising a substrate, an application-specific integrated circuit chip (ASIC), an acoustic wave transducer module and a cover, wherein the application-specific integrated circuit chip (ASIC) is mounted on the substrate and electrically connected with the substrate. The acoustic wave transducer module is mounted on the application-specific integrated circuit chip (ASIC), and electrically connected to the application-specific integrated circuit chip (ASIC) using Ball Grid Array (BGA) packaging technology, enabling an acoustic wave to pass through the gap between the acoustic wave transducer module and the application-specific integrated circuit chip (ASIC). The cover is covered over the acoustic wave transducer module and connected to the substrate, defining therein a sound hole.

Thus, the chip-stacked microphone of the present invention has the acoustic wave transducer module be stacked on application-specific integrated circuit chip (ASIC) without making any hole on the application-specific integrated circuit chip (ASIC), effectively reducing the area requirement for footprint to minimize the area of the substrate, and fully utilizing the space between the two modules and the cover for back chamber to maintain the overall performance of the microphone.

Preferably, the application-specific integrated circuit chip (ASIC) is electrically connected to the substrate by wire bonding technology or flip chip bonding technology.

Preferably, the application-specific integrated circuit chip (ASIC) has a plurality of Through Silicon Vias formed therein for the application of Redistribution Layer (RDL) technology.

Further, the acoustic wave transducer module comprises a diaphragm, and the sound hole is disposed above the diaphragm. Preferably, the chip-stacked microphone further comprises a mask connected to the cover and covered over the sound hole.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a sectional view of a conventional microphone.

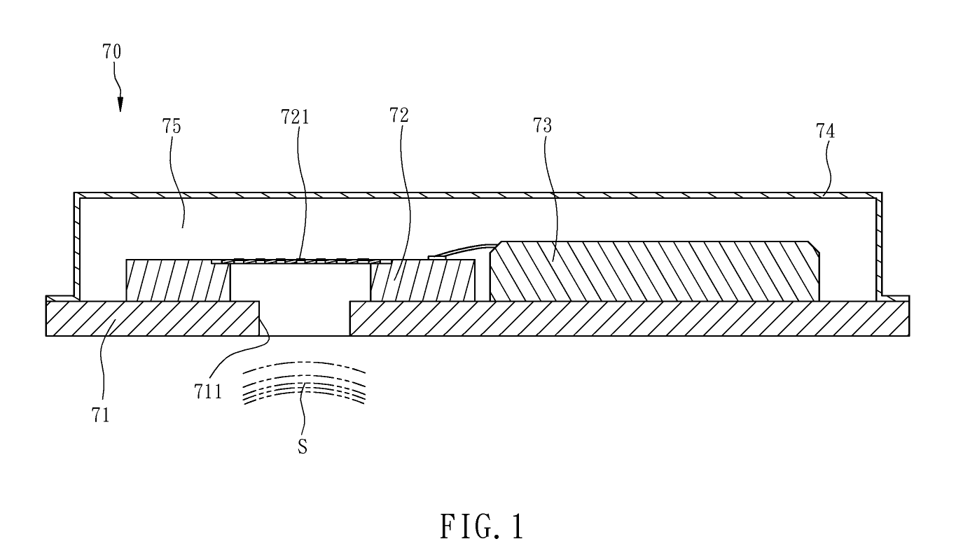

FIG. 2 is a sectional view of a chip-stacked microphone in accordance with a first embodiment of the present invention.

FIG. 3 is a sectional view of the chip-stacked microphone in accordance with a second embodiment of the present invention.

FIG. 4 is a sectional view of a chip-stacked microphone in accordance with a third embodiment of the present invention.

FIG. 5 is a sectional view of a chip-stacked microphone in accordance with a fourth embodiment of the present invention.

### DETAILED DESCRIPTION OF THE INVENTION

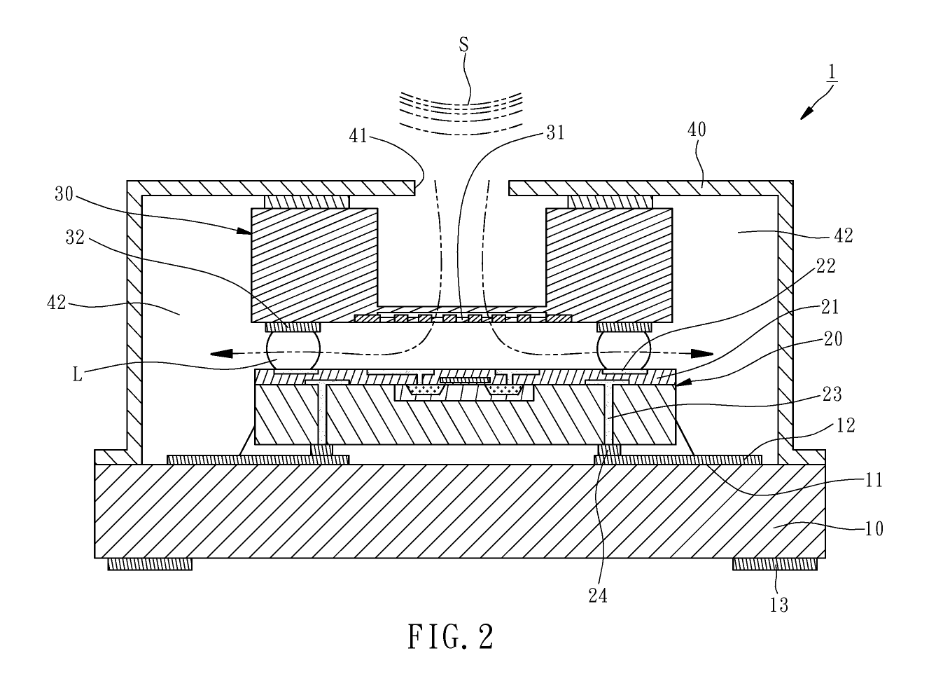

Referring to FIG. 2, a chip-stacked microphone 1 in accordance with a first embodiment of the present invention is shown. The chip-stacked microphone 1 comprises a substrate 10, an application-specific integrated circuit chip (ASIC) 20, an acoustic wave transducer module 30, and a cover 40. The structural details of these component parts and their relative relationship will be explained hereinafter.

The substrate 10 comprises a plurality of conducting regions 11 at a top wall thereof, at least one solder pad 12 at each conducting region 11, and a plurality of solder pads 13 at an opposing bottom wall thereof for electric connection with external components.

The application-specific integrated circuit chip (ASIC) 20 is mounted at and electrically connected with the substrate 10, comprising a circuit layer 21 located at a top wall thereof, a plurality of solder pads 22 mounted at the circuit layer 21, a plurality of metal bumps 24 located at an opposing bottom wall thereof, and a plurality of Through Silicon Vias (TSVs) 23 extending through the opposing top and bottom walls with respective opposing top and bottom ends thereof respectively electrically connected to the solder pads 22 and the metal bumps 24. Thus, the application-specific integrated circuit chip (ASIC) 20 can be electrically connected to the solder pads 12 at the substrate 10 using flip chip bonding technology for allowing input of drive voltage of the microphone 1 and input/output of signals of the microphone 1.

The acoustic wave transducer module 30 is mounted at a top side relative to the application-specific integrated circuit chip (ASIC) 20, comprising a diaphragm 31 and a plurality of solder pads 32 disposed adjacent to one side of the diaphragm 31. The solder pads 32 of the acoustic wave transducer module 30 are respectively electrically connected to the respective solder pads 22 at the circuit layer 21 of the application-specific integrated circuit chip (ASIC) 20 with solder balls L using Ball Grid Array (BGA) packaging technology, thereby electrically connecting the acoustic wave transducer module 30 to the application-specific integrated circuit chip (ASIC) 20.

The cover 40 is covered over the acoustic wave transducer module 30, and connected to the substrate 10 beyond the conducting regions 11. The cover 40 can be made of metal to protect the microphone 1 against impact, external dust and magnetic waves. Further, the cover 40 has a sound hole 41 disposed above the diaphragm 31 of the acoustic wave transducer module 30, allowing acoustic wave S to be directly transmitted through the sound hole 41 to the diaphragm 31. Further, the inner wall of the cover 40 defines with the outer wall of the acoustic wave transducer module 30 and the outer wall of the application-specific integrated circuit chip (ASIC) 20 a back chamber 42.

In application, when the chip-stacked microphone 1 receives an acoustic wave, the acoustic wave S goes through the sound hole 41 and the acoustic wave transducer module 30 to vibrate the diaphragm 31. Further, the arrangement of the solder balls L between the acoustic wave transducer module 30 and the application-specific integrated circuit chip (ASIC) 20 causes formation of a passage between the application-specific integrated circuit chip (ASIC) 20 and the acoustic wave transducer module 30 for the passing of the acoustic wave S to the back chamber 42, enabling the acoustic wave S to induce acoustic wave resonances in the back chamber 42 and to further improve the performance of the chip-stacked microphone 1 for intaking sound from the back. In spatial utilization, the acoustic wave transducer module 30 is stacked on the application-specific integrated circuit chip (ASIC) 20, and the application-specific integrated circuit chip (ASIC) 20 is electrically connected to the substrate 10 through the Through Silicon Vias 23, minimizing the requirement for footprint for the application-specific integrated circuit chip (ASIC) 20.

It is to be noted that the application of Ball Grid Array (BGA) packaging technology in the present invention enables the acoustic wave transducer module 30 to be electrically connected to the application-specific integrated circuit chip (ASIC) 20, however, the invention is not limited to the application of Ball Grid Array (BGA) packaging technology, any person skilled in the art can employ Plastic Ball Grid Array (PBGA) technology and Flip Chip Ball Grid Array (FCBGA) technology, or any other substitute three-dimensional (3D) Packaging technology, such as Package on Package (PoP) or Stacked Die Package technology to electrically connect the acoustic wave transducer module 30 to the application-specific integrated circuit chip (ASIC) 20, allowing an acoustic wave to pass through the back chamber.

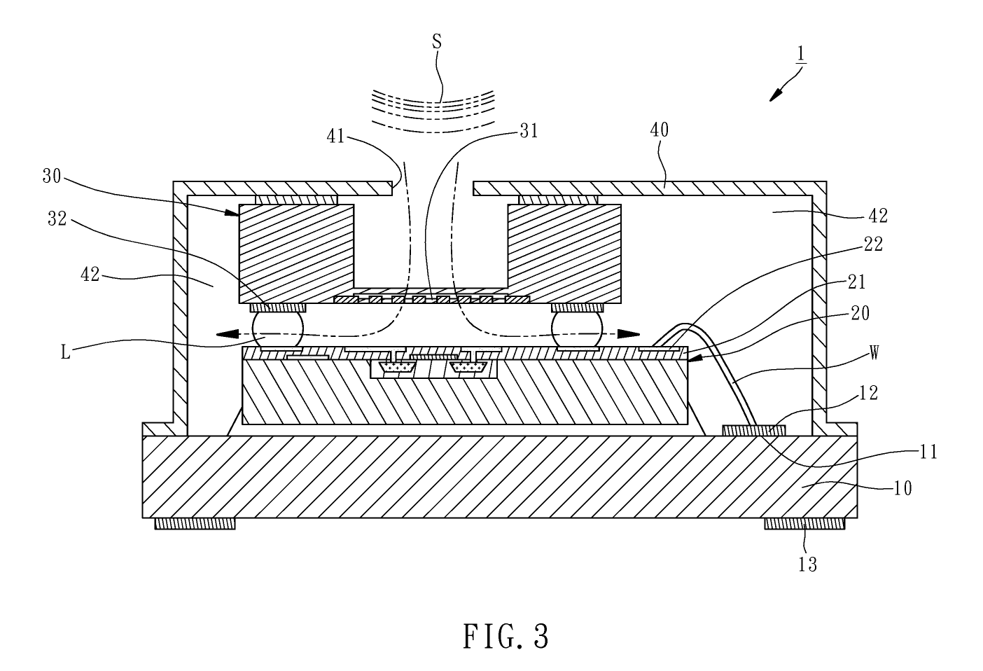

Referring to FIG. 3, a chip-stacked microphone 1 in accordance with a second embodiment of the present invention is shown. This second embodiment is substantially similar to the aforesaid first embodiment with the exception that the application-specific integrated circuit chip (ASIC) 20 is electrically connected to the solder pads 22 of the application-specific integrated circuit chip (ASIC) 20 and another solder pads 12 of the substrate 10 with lead wires W using wire bonding technology.

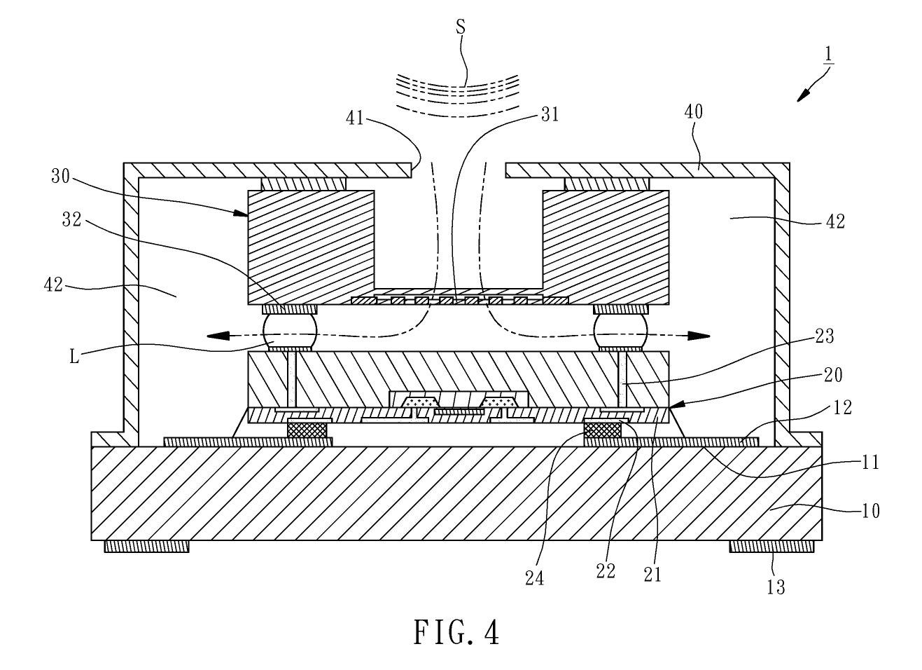

Referring to FIG. 4, a chip-stacked microphone 1 in accordance with a third embodiment of the present invention is shown. This third embodiment is substantially similar to the aforesaid first embodiment with the exception that the application-specific integrated circuit chip (ASIC) 20 has a plurality of Through Silicon Vias 23 downwardly extended from the top wall thereof to match with the solder balls L, enabling the acoustic wave transducer module 30 to be electrically connected to the application-specific integrated circuit chip (ASIC) 20 through the solder balls L and the Through Silicon Via 23 using Redistribution Layer (RDL) technology. Further, in this embodiment, the circuit layer 21 is mounted at the bottom wall of the application-specific integrated circuit chip (ASIC) 20 and provided with a plurality of solder pads 22, and a metal bump 24 at each solder pad 22, enabling the application-specific integrated circuit chip (ASIC) 20 to be electrically connected to the solder pads 12 of the substrate 10 through the solder pads 22 and the metal bumps 24.

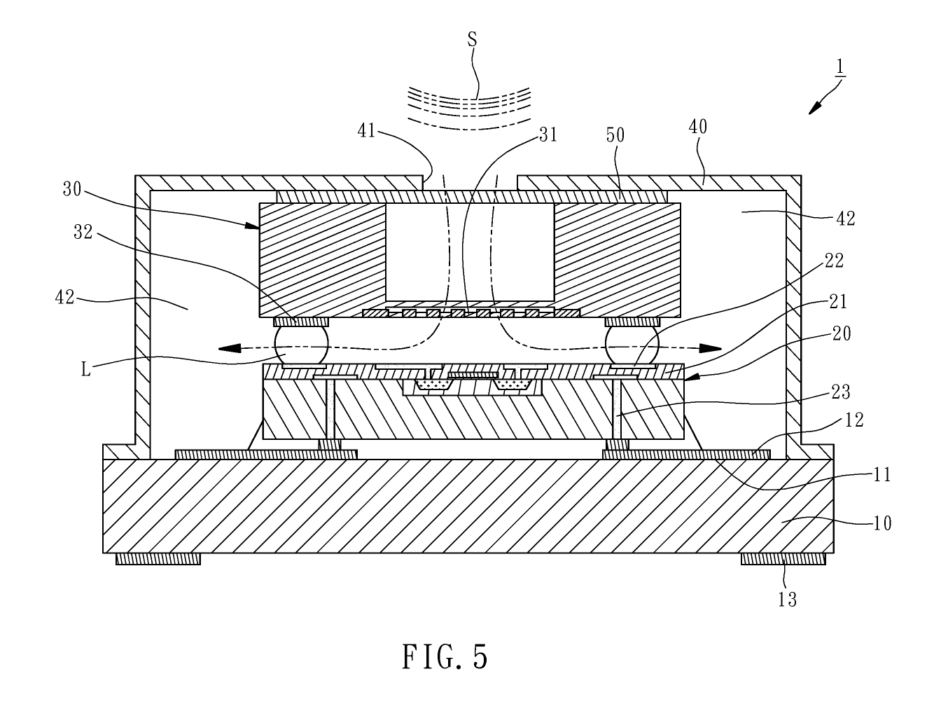

Referring to FIG. 5, a chip-stacked microphone 1 in accordance with a fourth embodiment of the present invention is shown. This fourth embodiment is substantially similar to the aforesaid first embodiment with the exception that the chip-stacked microphone 1 of this fourth embodiment further comprises a mask 50 adapted for prohibiting dust from falling to the diaphragm 31 of the acoustic wave transducer module 30. The mask 50 is connected to the cover 40 and covered over the sound hole 41.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A chip-stacked microphone, comprising:
a substrate;
a cover covering said substrate, said cover comprising a sound hole for the passing of an acoustic wave;
an application-specific integrated circuit chip (ASIC) mounted on said substrate within said cover and electrically connected to said substrate; and
an acoustic wave transducer module stacked on said application-specific integrated circuit chip (ASIC) and electrically connected to application-specific integrated circuit chip (ASIC) for enabling said acoustic wave to go through the gap between said acoustic wave transducer module and said application-specific integrated circuit chip (ASIC).

2. The chip-stacked microphone as claimed in claim 1, wherein said application-specific integrated circuit chip (ASIC) is electrically connected to said substrate using wire bonding technology.

3. The chip-stacked microphone as claimed in claim 1, wherein said application-specific integrated circuit chip (ASIC) is electrically connected to said substrate using flip chip bonding technology.

4. The chip-stacked microphone as claimed in claim 1 or 3, wherein said application-specific integrated circuit chip (ASIC) comprises a circuit layer and a plurality of Through Silicon Vias, each said Through Silicon Via having one end thereof electrically connected to said circuit layer.

5. The chip-stacked microphone as claimed in claim 4, wherein said circuit layer is located at a top wall of said application-specific integrated circuit chip (ASIC) and comprising a plurality of solder pads; each said Through Silicon Via has a metal bump mounted at an opposite end thereof remote from said circuit layer and electrically connected to said substrate.

6. The chip-stacked microphone as claimed in claim 4, wherein said circuit layer is located at a bottom wall of said application-specific integrated circuit chip (ASIC); each said Through Silicon Via has a solder pad mounted at an opposite end thereof remote from said circuit layer for electrically connecting to said acoustic wave transducer module.

7. The chip-stacked microphone as claimed in claim 6, wherein the solder pads of said application-specific integrated circuit chip (ASIC) are arranged using Redistribution Layer (RDL) technology.

8. The chip-stacked microphone as claimed in claim 1, wherein said acoustic wave transducer module comprises a diaphragm; said sound hole is disposed above said diaphragm.

9. The chip-stacked microphone as claimed in claim 8, further comprising a mask connected to said cover and covered over said sound hole.

10. The chip-stacked microphone as claimed in claim 1, wherein said acoustic wave transducer module is electrically connected to said application-specific integrated circuit chip (ASIC) using Ball Grid Array (BGA) packaging technology.

11. The chip-stacked microphone as claimed in claim 10, wherein said Ball Grid Array (BGA) packaging technology is one of Plastic Ball Grid Array (PBGA) technology and Flip Chip Ball Grid Array (FCBGA) technology.

12. The chip-stacked microphone as claimed in claim 1, wherein said acoustic wave transducer module is electrically connected to said application-specific integrated circuit chip (ASIC) using the packaging technology of package on package (PoP).

13. The chip-stacked microphone as claimed in claim 1, wherein said acoustic wave transducer module is electrically connected to said application-specific integrated circuit chip (ASIC) using the packaging technology stacked die package.

14. The chip-stacked microphone as claimed in claim 1, wherein said acoustic wave transducer module is electrically connected to said application-specific integrated circuit chip (ASIC) with a plurality of solder balls.
